(19) United States
(12) Patent Application Publication
(10) Pub. No.: US 2010/0131356 A1
(43) Pub. Date: May 27, 2010

(54) Methods and Systems of Measuring the Effectiveness of Advertising Content and Producing Standardized Advertising Content Effectiveness Scores

(76) Inventors: JuYoung Lee Stevens, Glendale (CA); Steven Howard Goldman, Agoura, CA (US)

Correspondence Address: WILSON, SONSINI, GOODRICH & ROSATI, 650 PAGE MILL ROAD, PALO ALTO, CA, 94304-1050, US

(21) Appl. No.: 12/622,326

(22) Filed: Nov. 19, 2009

Related U.S. Application Data
(60) Provisional application No. 61/117,077, filed on Nov. 21, 2008.

(51) Int. Cl. G06Q 30/00; G06Q 10/00

(52) U.S. Cl. 705/14.44

(57) ABSTRACT

Methods and systems for measuring effectiveness of advertisements. Consumers who opt-in may be presented with advertisements, and after viewing the advertisements, the participants may be asked to respond to the advertisement in a standardized survey environment. The participants may be asked to rate, on a scale of 0 to 100, each advertising piece in terms of various factors such as: desire rating, relevance, information, attention, innovation (or change), likeability, etc. These responses, combined with demographic information about the participants and meta data pertaining to advertising such as brand, product and the media that the advertising is designed for, may be used to measure the persuasive power of the advertising content, the likelihood of repeat viewing of the advertising, the likelihood of having word-of-mouth effect and the overall effectiveness of advertising content. Consumer reactions may be continuously collected, and advertising content effectiveness scores may be provided in a standardized, quantitative way. The results may also provide a cost per ad effectiveness, calculated based on the money spent on the advertisement, breadth of audience, and the advertising content effectiveness score.

### CROSS-REFERENCE

This application claims the benefit of U.S. Provisional Application No. 61/117,077 filed Nov. 21, 2008 which application is incorporated herein by reference in its entirety.

### BACKGROUND

The objective of advertising research may seem rather straightforward, predict or evaluate how an advertisement will be or is perceived in the real world. Evaluating advertisements, however, may be very complex and difficult.

Advertising measurement systems may seek to answer certain questions such as whether the advertising breaks through the clutter of other advertising, or may seek to determine what elements in the advertising attract attention. It may also be sought to determine what the advertisement communicates to the viewers, or what is persuasive and believable about the advertisements.

One known method for measuring what is being communicated to viewers is the so-called “eye tracking” method. This method is very expensive and involves intricate equipment. The eye tracking method assesses what the viewer sees by using a special camera that tracks the motion of a person's eyes as he or she looks at an advertisement on paper or on a monitor. The camera captures critical information such as what a person sees first, what element has the greatest impact on the viewer, what words the person sees and whether the brand's logo is identified.

While the eye-tracking method can determine what the person sees, the eye-tracking method cannot determine what the person actually thinks of the advertisements both in whole and in part, and cannot measure other effects of the advertising on the individual. Further, the eye-tracking method requires people to be tested from some central fixed location. These methods are expensive to conduct and constrained by the number of people who visit the fixed location.

Accordingly, it is desirable to provide a method for obtaining advertising research data without the need for complicated and cumbersome equipment and that can be obtained from a multitude of locations and participants. Further, it is an objective of this invention to measure reaction data and other responses for a multitude of different types of presentations audibly and/or visually over a communication network such as the Internet.

### SUMMARY OF INVENTION

The invention provides methods and systems of measuring the effectiveness of advertising content and producing standardized advertising content effectiveness scores. Various aspects of the invention described herein may be applied to any of the particular applications set forth below. The invention may be applied as a standalone system or as a component of an integrated software solution measuring advertisement effectiveness. The invention can be optionally integrated into existing businesses and processes seamlessly. It shall be understood that different aspects of the invention can be appreciated individually, collectively or in combination with each other.

One aspect of the present invention provides methods and systems for measuring effectiveness of advertisements. Consumers who opt-in may be presented with advertisements, such as offline ads (e.g., a television commercial that has been digitized for delivery over the Internet), and after viewing the advertisements, the participants may be asked to respond to the advertisement in a standardized survey environment.

The participants may be asked to rate, on a scale of 0 to 100, each advertising piece in terms of its ability to make them feel that: the advertising attracts their attention, the advertising is relevant to them, the advertising increases desire, the advertising is informative, the advertising changes their perception about the brand, they like the advertising, they want to watch the advertising again, etc. These responses, combined with demographic information about the participants and meta data pertaining to advertising such as brand, product and the media that the advertising is designed for, may be used to measure the persuasive power of the advertising content, the likelihood of repeat viewing of the advertising, the likelihood of having word-of-mouth effect and the overall effectiveness of advertising content.

Various embodiments of the present invention may be developed to continuously collect consumer reactions to advertisements and score those reactions in a standardized, quantitative way. The results may also provide a cost per ad effectiveness, calculated based on the money spent on the advertisement, breadth of audience, and the advertising content effectiveness score.

Unless specifically stated otherwise, as apparent from the following discussions, it is appreciated that throughout the specification, discussions utilizing terms such as “processing,” “computing,” “calculating,” “determining,” or the like, may refer in whole or in part to the action and/or processes of a processor, computer or computing system, or similar electronic computing device, that manipulate and/or transform data represented as physical, such as electronic, quantities within the system's registers and/or memories into other data similarly represented as physical quantities within the system's memories, registers or other such information storage, transmission or display devices. It will also be appreciated by persons skilled in the art that the terms “users” or “participants” referred to herein can be individuals as well as corporations and other legal entities. Furthermore, the processes presented herein are not inherently related to any particular computer, processing device, article or other apparatus. An example of a structure for a variety of these systems will appear from the description below. In addition, embodiments of the present invention are not described with reference to any particular processor, programming language, machine code, etc. It will be appreciated that a variety of programming languages, machine codes, etc. may be used to implement the teachings of the invention as described herein.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

Some of the features of the invention are described as set forth in the following figures and description. A better understanding of the features and advantages of the invention will be obtained by reference to the following detailed description that sets forth illustrative embodiments provided in accordance with the invention.

FIG. 1 illustrates one example of a system for measuring the effectiveness of advertising content and producing standardized advertising content effectiveness scores, according to one embodiment of the invention.

FIG. 2 shows a flowchart for one example of how data may be interpreted to create an advertising content effectiveness score.

FIG. 3 shows an example of the various factors that may make up the advertising content effectiveness score.

FIG. 4 shows another example of how data may be interpreted to calculate the cost per ad effectiveness.

### DETAILED DESCRIPTION OF INVENTION

In the following detailed description, numerous specific details are set forth in order to provide a thorough understanding of the invention. However it will be understood by those of ordinary skill in the art that the invention may be practiced without these specific details. In other instances, well-known methods, procedures, components and circuits have not been described in detail so as not to obscure the invention. Various modifications to the described embodiments will be apparent to those with skill in the art, and the general principles defined herein may be applied to other embodiments. The invention is not intended to be limited to the particular embodiments shown and described.

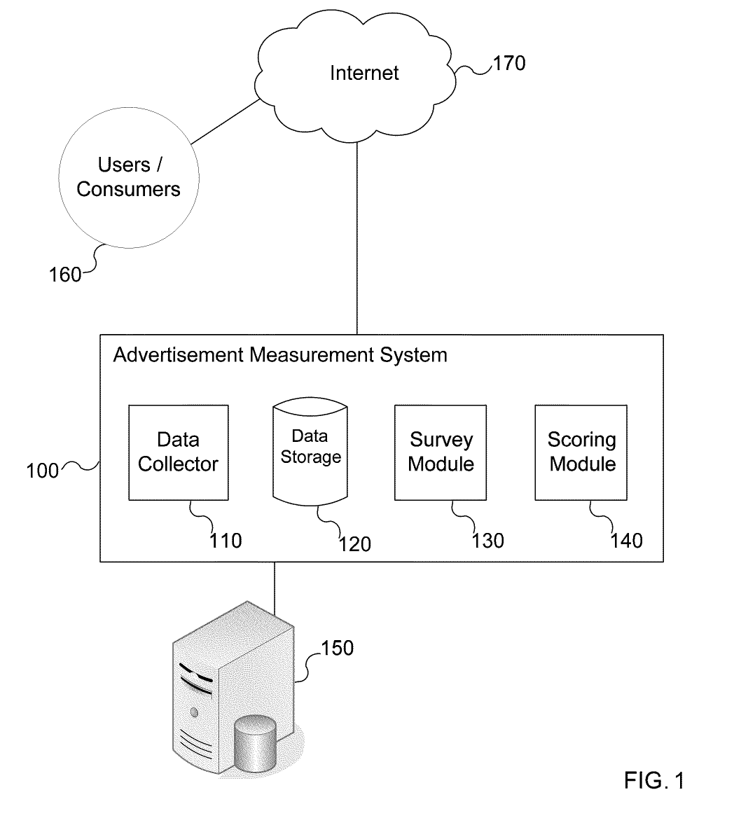

FIG. 1 illustrates one example of a system for measuring the effectiveness of advertising content and producing standardized advertising content effectiveness scores, according to one embodiment of the invention. The software and deployment system may measure consumer reaction to advertising's content immediately after seeing it and produce standardized advertising content effectiveness scores. The system may involve developing (1) standardized survey questionnaires applicable to advertising of all products and brands, (2) a survey engine that enables consumer surveys based on stimulus-response methodology over the Internet, and (3) scoring algorithms that produce standardized advertising content effectiveness scores based on survey data. The objective of some embodiments of the present invention may be to evaluate how advertisements (such as offline advertisements) are perceived in the real world.

As described more fully below, the system allows a multitude of participants to view presentations such as an advertisement with static or moving images, marketing information, brochures, sales information, live or recorded speeches, television programs, movies, videos, music, computer graphics, computer games or any other media which can be projected audibly and/or visually over the Internet and record their reactions and thoughts about the presentation through a series of requests and questions based on their reactions. More specifically, the system may allow participants to view and provide reactions for offline advertising such as a television commercial that has been digitized for delivery over the Internet.

Using the interactivity of the Internet, embodiments of the present invention may provide useful data and advertising content effectiveness scores derived from effective web-based research data on presentations such as offline advertisements, responses collected from participants who have viewed the advertising, and demographic information (or profile information) of such survey participants, along with meta data pertaining to advertising such as brand, product and the media that the advertising is designed for. Further, embodiments of the present invention may provide powerful insights into why, for example, advertising does and does not work. The results and advertising content effectiveness scores may attempt to provide guidance as to how effective advertising content is based on measures of consumer reactions to advertising content, immediately after seeing it.

According to one embodiment of the invention, the research participant is asked to view an advertisement over a network such as the Internet and record their reactions to the advertisements using a mouse or keyboard controls (or other controls). The participant can then be asked a series of questions regarding the advertisement which assesses the ability of the advertising piece in terms of its ability to make the participant feel that: the advertising attracts their attention; the advertising is relevant to them; the advertising increases desire; the advertising is informative; the advertising changes their perception about the brand; they like the advertising; or they want to watch the advertising again. The survey questionnaire may ask consumers to rate, on a scale of 0 to 100 for example, each advertising piece in terms of such criteria, and thus measure the creative effectiveness of the advertisement. It will be understood by those skilled in the art that the advertisement can be a video, slide show, animation, flash animation, or any other type of advertisement. Further, the advertisement may be an offline advertisement, such as a television commercial that has been digitized for delivery over the Internet.

Referring to FIG. 1, in one embodiment, the system may include an advertisement measurement system 100 which measures the creative effectiveness of the advertising. The advertisement measurement system 100 may include a data collector 110, a data storage 120, a survey module 130, and a scoring module 140. Each of these modules and storage may be managed through a server coupled with a database 150. There may be multiple servers, such as server 150, and each may include software operating on one or more computer systems, at one or more locations. Further, it can be appreciated that one or more users/consumers (participants) 160 may access the advertisements measurement system 100 over the Internet 170 at any given time.

A survey engine may be a part of the survey module 130, and may enable consumer surveys based on stimulus-response methodology over the Internet. For example, a user or participant may be presented with offline advertising such as a TV commercial that has been digitized for delivery over the Internet. The presentation may be to opt-in consumers within a standardized survey environment. The survey engine, as part of the survey module 130, may then provide a standardized survey questionnaire or in some other way elicit responses from the consumer or participant. The survey engine within the survey module 130 may then collect the responses immediately after seeing the advertising, perhaps in conjunction with the data collector 110. The survey module 130 may also store the responses in data storage 120. In addition, demographic information of the survey participants and meta data pertaining to advertising such as brand, product and the media that the advertising is designed for may also be stored in data storage 120.

According to one embodiment of the invention, the advertisement may be shown to the participant and the participant may use a mouse or various keys on a keyboard or some other input device to move an indication marker on a meter from one side to the other side depending on the participant's reactions to the advertisement. Or, the participant may enter a certain score, for example, a score on a scale from 0 to 100, depending on certain reactions or responses that the participant may have to the advertisement. The participant's responses may be collected by the data collector 110, for example, in a data array, and then sent via the network or Internet 170 and stored in data storage 120. Software in the server and/or associated computer 150 may analyze and interpret the received data as will be described in more detail below.

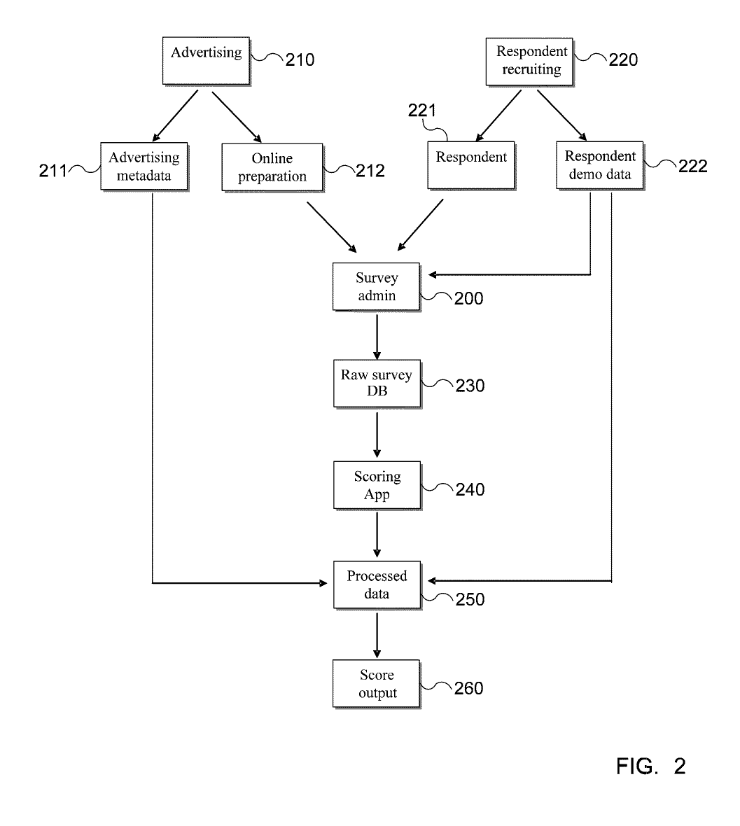

Referring to FIG. 2, the survey administrator may take in several kinds of data as inputs, in order to produce a score output (an advertising content effectiveness score) 260, which may provide guidance to measuring the effectiveness of advertising content. In one embodiment, an offline advertisement such as a television commercial may be digitized for delivery over the Internet, or otherwise go through online preparation 212 so that it can be viewed by respondents 221 via the survey administrator 200. The survey administrator may, via a scoring application 240, present the respondents with a survey questionnaire to enable consumer surveys based on stimulus-response methodology over the Internet. When recruiting these respondents 220, demographic information (or profile information) and other respondent demographic data 222 of the survey participants may also be collected (e.g., sex, age, residency, income level, occupation, etc.).

The scoring application 240 may ask respondents 221 to rate, on a scale of 0 to 100, each advertising piece in terms of its ability to make them feel that: the advertising attracts their attention, the advertising is relevant to them, the advertising increases desire, the advertising is informative, the advertising changes their perception about the brand, they like the advertising, they want to watch the advertising again, etc. One skilled in the art can appreciate that various questions or ratings may be requested. The scoring application 240 may store these responses in the raw survey database 230. The scoring application may combine such raw survey data from the raw survey database 230 with advertising metadata 210, which may include the brand, product and the media that the advertising is designed for, and respondent demographic data 222, to form processed data 250. This processed data 250 may be manipulated by a scoring algorithm to create an advertising content effectiveness score for the advertisement 260.

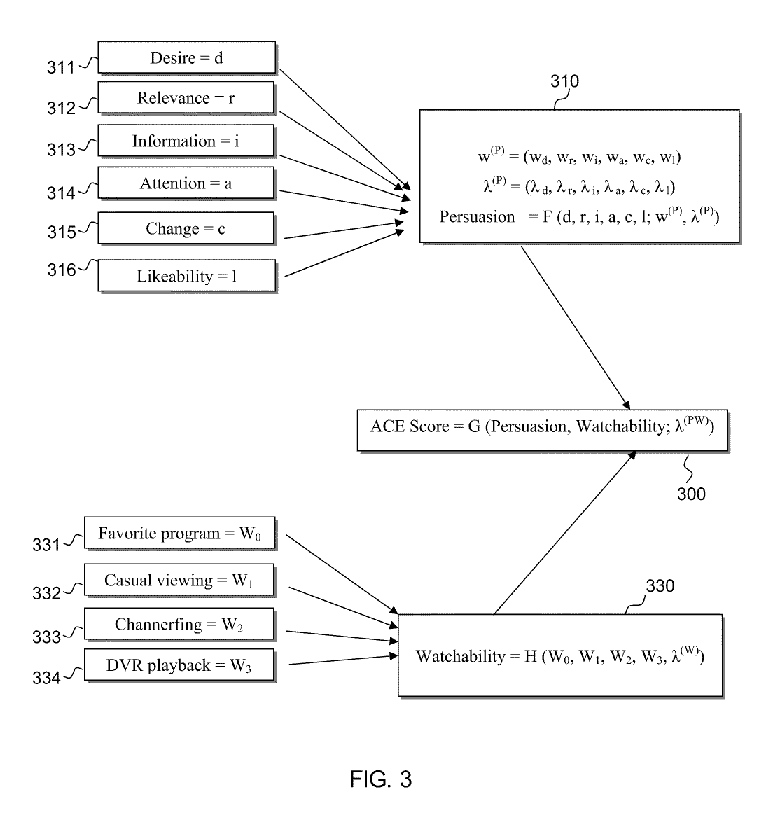

Referring to FIG. 3, several factors may be considered when creating the advertising content effectiveness score (ACE Score, A) 300 for the advertisement. In one embodiment of the invention, these factors may be divided into three general categories: (1) the persuasive power of the advertising content (persuasion) 310, (2) the likelihood of repeat viewing of advertising (watchability) 330, and (3) the likelihood of having word-of-mouth effect. Thus, composite scores may be created to convert the raw data from the survey participants into a series of composite scores that summarize each of the categories, as well as the overall effectiveness of the advertising content. Composite scores may be created based on persuasion 310, watchability 330, a combination of persuasion and watchability (Persuasion-Watchability interaction coefficient) (340), or other factors such as the likelihood of having word-of-mouth effect, and such scores may be combined and integrated to form the overall ACE Score 300.

For example, a user interface may use meters of horizontal bars or vertical bars or bars of any shape which the user may manipulate using his or her mouse or other input device to move the indication markers left or right to show certain measurements. Alternatively, the user may enter a score from 0 to 100. The user may also be asked a series of question and indicate whether they agree or disagree or to what extent they agree/disagree (e.g., strongly agree, agree, strongly disagree, neutral). It will be understood by those skilled in the art that various types of survey questions are known and may be implemented by various embodiments of the invention.

The responses, measurements or scores may indicate the level of interest in the advertisement, the believability of the advertisement, or other factors such as desire ratings, relevance, information, attention, innovation (or change), or likeability. The measurements may also assess watchability and whether the advertisement will be watched again when viewed with a favorite program, while casually viewing, while channel surfing, or on DVR playback. It will be understood by those skilled in the art that any number of measurements or factors may be assessed on the advertisement concept to gage different reactions and emotions and the invention is not limited thereto. Thus, participants may be asked to indicate their reactions or provide responses to any number of different categories, questions or other types of prompts.

For example, referring to FIG. 3, measurements or scores may be based on the persuasive power of advertising content. When measuring persuasion 310, several factors 311-316 may be evaluated. The advertisement's persuasion 310 may be measured by a desire rating (d) 311, which may ask a consumer to rate, on a scale of 0 to 100, the advertising piece in terms of its ability to make them feel that the advertising increases desire. The advertisement's persuasion 310 may also be measured in part by its relevance (r) 312, which may ask a consumer to rate, on a scale of 0 to 100, the advertising piece in terms of its ability to make them feel that the advertising is relevant to them. The advertisement's persuasion 310 may also be measured in part by its information (i) 313, which may ask a consumer to rate, on a scale of 0 to 100, the advertising piece in terms of its ability to make them feel that the advertising is informative. The advertisement's persuasion 310 may also be measured in part by its attention (a) 314, which may ask a consumer to rate, on a scale of 0 to 100, the advertising piece in terms of its ability to make them feel that the advertising attracts their attention. The advertisement's persuasion 310 may also be measured in part by its innovation or change (c) 315, which may ask a consumer to rate, on a scale of 0 to 100, the advertising piece in terms of its ability to make them feel that the advertising is innovative. The advertisement's persuasion 310 may also be measured in part by its likeability (1) 316, which may ask a consumer to rate, on a scale of 0 to 100, the advertising piece in terms of its ability to make them feel that they like the advertising. It is appreciated that different interaction coefficients, factors or variables not specified or described here are contemplated, and further that consumers or participants may use different scales, and that providing scores from 0 to 100 is not the only way to provide responses.

Each persuasion variable or factor may have a corresponding weight, such that w^{(P)}=(w_{d}, wᵣ, wᵢ, wₐ, w_{c}, wₗ). Each persuasion variable or factor may also have an interaction coefficient λ^{(P)}=(λ_{d}, λᵣ, λᵢ, λₐ, λ_{c}, λₗ). Thus, persuasion P is given as P=F(d, r, i, a, c, l; w^{(P)}, λ^{(P)}), where F(d, r, i, a, c, l; w^{(P)}, λ^{(P)}) is the persuasion integration function.

As another example, after viewing an advertisement, the participant may be asked to provide a series of scores from 0 to 100 indicating certain ratings for: desire, relevance, information, attention, innovation (or change), or likeability. Participants may also be asked to indicate their levels of agreement/disagreement with certain statements. For example, the participants may be asked whether the advertisements were attention getting, persuasive, memorable, etc. It will be appreciated by those skilled in the art that the invention is not limited to these factors, but that any number of factors may be considered. In some embodiments of the invention, these questions are standardized, such that the survey questionnaire may be applicable to advertising of all products and brands, and across markets. Thus, the advertising content effectiveness scores created will also be standardized scores based on the survey data. Therefore, it is possible to continuously collect consumer reactions to advertising's creative content, and score the reaction in a standardized, qualitative way and build a database that enables data retrieval, analysis and data mining based on such consumer reactions and scores.

In addition to the level of persuasion of the advertising, the likelihood of repeat viewing of advertising (or “watchability”) 330 may also be considered when calculating the ACE score 300. In assessing the watchability 330 of an advertisement, the system may track whether the advertisement is watched again with a counter, and also the method in which it is watched (e.g., as a participant's favorite program (W₀) 331, as part of casual viewing (W₁) 332, while channel surfing (W₂) 333, while in DVR playback mode (W₃) 334, or some other method). Alternatively, a participant may be asked whether the advertisement is a favorite program (W₀) 331, and rate this question on a scale from 0 to 100, or on some other scale (e.g., not likely, likely, very likely, etc.). A participant or consumer may also be asked whether they are likely to watch it again as part of casual viewing (W₁) 332, while channel surfing (W₂) 333, while in DVR playback mode (W₃) 334, or in some other context. It will be appreciated that the various examples of measuring watchability 330 are not limited to the specific questions or factors described herein and that other factors or questions are contemplated.

Thus, the watch again coefficient may be represented by λ^{(W)} and the total watchability W may then be written as W=H(W₀, W₁, W₂, W₃, λ^{(W)}), where H(W₀, W₁, W₂, W₃, λ^{(W)}) is the watchability integration function.

The final ACE score A can be calculated as a function of the persuasion P, the watchability W, and their interaction coefficient λ^{(PW)}, such that λ=G(P,W; λ^{(PW)}), where G(P,W; λ^{(PW)}) is the Persuasion-Watchability integration function.

As mentioned above, the data collector 110 records all of the information entered by the user/participant 160 and provides the collected data to the advertisement measurement system 100 via the Internet 170. It will be understood by those skilled in the art that a variety of different methods and devices can be used to extract the data from the user and the invention is not limited to the particular methods and devices described herein.

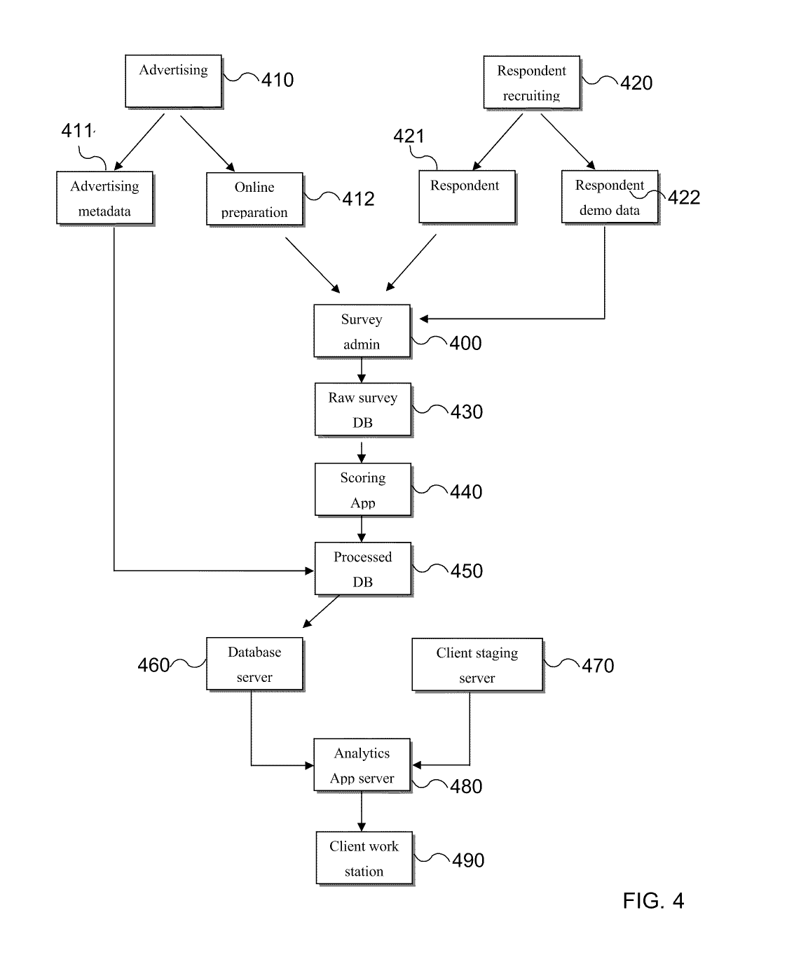

Referring to FIG. 4, the collected data which includes the advertising meta data 411 and respondent demographic data 422, along with the respondent's responses may be combined and stored in a database 450. A database server 460 may access this processed data from the database 450. An analytics application server 480 may work in conjunction with a database server 460 and client staging server 470 in order to calculate the cost per ad effectiveness of a particular advertisement. Thus, by using certain methods, it may be possible to assess the granular impact of advertising creativity on the silent majority (i.e., consumers who see the advertisement but take no immediate, measurable action) and calculate the return on investment (ROI) of the advertisement on those consumers. The outcome may be a cost per ad effectiveness (CPE) measurement, and may be able to compliment cost per click or cost per sale of an advertisement on the Internet or other medium.

The calculation of CPE may be calculated as follows: CPE=Spending/(Reach×Effectiveness Coefficient), where CPE is the cost per ad effectiveness, Reach is the number of audience participants reached (and may be rounded to the nearest hundred-thousand for example), and the Effectiveness Coefficient is the advertising content effectiveness score as described above. One skilled in the art will recognize that the Effectiveness Coefficient may be calculated in a number of ways, and may take into account advertising meta data, respondent demographic data, and participant's responses to consumer survey questionnaires regarding certain advertisements.

As mentioned above, the systems and methods described herein may be used to collect research data on a wide variety of presentations such as an advertisement with static or moving images, an offline advertisement such as a television commercial that has been digitized for delivery over the Internet, marketing information, brochures, sales information, live or recorded speeches, television programs, movies, videos, music, computer graphics, computer games or any other media which can be projected audibly and/or visually over a communication system.

All concepts of the invention may be incorporated or integrated with other systems and methods for research on advertisements, including but not limited to those described in U.S. Patent Publication No. 2005/0246734 A1 (Kover et al.) published on Nov. 3, 2005, which is hereby incorporated by reference in its entirety.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for measuring effectiveness of advertising content comprising:
selecting an advertisement for marketing a product or service offered by a vendor;
presenting a series of survey questions for measuring consumer reaction to advertising content, wherein the survey questions are administered to a plurality of consumers following the consumer's viewing of the advertisement; and
calculating a standardized advertising content effectiveness score, wherein the standardized advertising content effectiveness score is based on at least one of the following: a persuasion index, a watchability index, demographic information relating to the plurality of consumers, or metadata relating to the advertisement;
wherein the persuasion index is directed to the consumer's impression about a brand of the vendor; and
wherein the watchability index is directed to the consumer's interest in watching the advertisement again.

2. The method of claim 1, wherein at least one survey question is directed to the consumer's attention of the advertisement.

3. The method of claim 1, wherein at least one survey question is directed to how relevant was the advertisement to the consumer.

4. The method of claim 1, wherein at least one survey question is directed to how informative was the advertisement to the consumer.

5. The method of claim 1, wherein at least one survey question is directed to how desirable was a subject of the advertisement to the consumer.

6. The method of claim 1, wherein at least one survey question is directed to how innovative was the advertisement to the consumer.

7. The method of claim 1, wherein at least one survey question is directed to how likeable was the advertisement to the consumer.

8. The method of claim 1, wherein the advertisement comprises static or moving images.

9. The method of claim 1, wherein the advertisement comprises live or recorded speech.

10. The method of claim 1, wherein the advertisement comprises a television commercial delivered over the Internet.

11. The method of claim 1, wherein the metadata relating to the advertisement reflects a brand.

12. The method of claim 1, wherein the metadata relating to the advertisement reflects a product.

13. The method of claim 1, wherein the metadata relating to the advertisement reflects a media that the advertisement was designed for.

14. The method of claim 1, wherein the demographic information includes the sex, age, residency, and income level of the consumer.

15. A system for measuring effectiveness of advertising content comprising:
a network for providing a consumer access to view an advertisement for marketing a product or service offered by a vendor;
a survey module for administering a series of survey questions for measuring consumer reaction to advertising content, wherein the survey questions are administered to the consumer following the consumer's viewing of the advertisement;
a data storage for collecting and storing responses to the series of survey questions, demographic information relating to the consumer, and metadata relating to the advertisement; and
a standardized advertising content effectiveness score, wherein the standardized advertising content effectiveness score is based on at least one of the following: a persuasion index, a watchability index, demographic information relating to the plurality of consumers, or metadata relating to the advertisement;
wherein the persuasion index is directed to the consumer's impression about a brand of the vendor; and
wherein the watchability index is directed to the consumer's interest in watching the advertisement again.

16. The system of claim 15, further comprising a tracking module for tracking whether the advertisement is watched by the consumer again, wherein the standardized advertising content effectiveness score is based on data collected by the tracking module.

17. The system of claim 15, wherein the tracking module tracks whether the advertisement is watched by the consumer again via casual viewing, channel surfing, in DVR playback mode, or in some other context.

18. The system of claim 15, wherein the scoring module calculates a cost per effectiveness (CPE) measurement, wherein CPE=Spending/(Reach*ACE), wherein Spending is a dollar amount spent to broadcast the advertisement and reach is a number of consumers participating in answering the survey questions.

19. A computer-usable medium having computer readable instructions stored thereon for execution by a processor to perform a method for measuring effectiveness of advertising content comprising:
selecting an advertisement for marketing a product or service offered by a vendor;
presenting a series of survey questions for measuring consumer reaction to advertising content, wherein the survey questions are administered to a plurality of consumers following the consumer's viewing of the advertisement; and
calculating a standardized advertising content effectiveness score, wherein the standardized advertising content effectiveness score is based on at least one of the following: a persuasion index, a watchability index, demographic information relating to the plurality of consumers, or metadata relating to the advertisement;
wherein the persuasion index is directed to the consumer's impression about a brand of the vendor; and
wherein the watchability index is directed to the consumer's interest in watching the advertisement again.
